(19) United States
(12) Patent Application Publication
(10) Pub. No.: US 2005/0082766 A1
(43) Pub. Date: Apr. 21, 2005

(54) Low adhesion additive

(75) Inventors: Michel K. Lovell, Marshalltown, IA (US); Ted D. Grabau, Marshalltown, IA (US); Wilbur D. Hutchens, Marshalltown, IA (US); Jason G. Olberding, Marshalltown, IA (US); Harry C. Champlin, Mystic, CT (US)

Correspondence Address: MARSHALL, GERSTEIN & BORUN LLP, 6300 SEARS TOWER, 233 S. WACKER DRIVE, CHICAGO, IL, 60606, US

(73) Assignee: FISHER CONTROLS INTERNATIONAL, Marshalltown, IA (US)

(21) Appl. No.: 10/688,403

(22) Filed: Oct. 15, 2003

(51) Int. Cl. F16J 15/18

(52) U.S. Cl. 277/510

(57) ABSTRACT

An apparatus for sealing an operating member of a sliding or rotating assembly includes a seal formed by a composition of materials. A plurality of abrasive particles are incorporated into the composition and thus positioned within the seal. The abrasive particles are disposed to remove an amount of material adhering to the operating member, caused primarily by graphite adhesion. The composition forming the seal can be in the form of a laminate structure, and made of graphite, or graphite and polytetrafluoroethylene (“PTFE”). The plurality of abrasive particles can be selected to be suitable for removing material, while not substantially damaging a surface of the operating member.

### FIELD OF THE INVENTION

The present invention relates to a seal or packing arrangement within a sliding or rotating assembly, and more particularly to the inclusion of abrasive particles in one or more components of a seal or packing arrangement to substantially hinder the adhesion of the seal or packing material to one or more components of the sliding or rotating assembly.

### BACKGROUND OF THE INVENTION

Generally, pressure-retaining devices that utilize sliding or rotating assemblies will contain a packing arrangement. The packing arrangement provides a guiding or bearing surface and/or a fluid seal assembly. For example, in conventional valve assemblies, an actuator moves an operating member located within a valve body. Valve packing is fixed about the operating member to prevent fluid from leaking around the operating member, while also providing a guide for the valve operating member as it moves relative to the valve body. Typically, the packing arrangements are formed of one or more resilient members placed under high compressive load within a packing box around the operating member. The compressive loading of several thousand pounds per square inch (e.g., 4000 psi) induces circumferential expansion of the packing, placing it in intimate contact with the operating member creating a fluid seal and/or a guiding or bearing surface.

Packing arrangements utilizing combinations of graphite and PTFE components have proven to provide excellent sealing capability and long cycle life. However, the life cycle of such conventional graphite packing can be dramatically reduced when the operating member is cycled at ambient conditions, such as about 70° F. The life cycle at lower temperatures is reduced because of accelerated wear. This accelerated wear is attributable to graphite adhesion to the operating member. At relatively low or ambient temperatures, the graphite found in some of the components of the packing arrangement tends to adhere to the operating member. As the operating member slides through the packing arrangement, graphite remains on the operating member until excessive buildup causes damage in the form of abrasion to the packing arrangement. The damage causes gaps or voids in the inner surface of the seal, thereby inhibiting seal performance.

### SUMMARY OF THE INVENTION

There is a need in the art for a packing arrangement that prevents seals and other internal packing arrangement components from being damaged by particles that adhere to an operating member, but have yet to come in contact with outer packing rings or wipers. The present invention is directed toward further solutions to address this need.

In accordance with one example embodiment of the present invention, a sealing ring has abrasive particles positioned therein at a location suitable for removing unwanted material or buildup on an operating member of a sliding assembly in which the sealing ring is removably and replacably mounted. The composition forming the sealing ring can be in the form of a laminate structure. The composition can further be formed of flexible graphite, or flexible graphite and polytetrafluoroethylene (“PTFE”). The abrasive particles can be selected to be suitable for removing the buildup, while not substantially damaging a surface of the operating member. In the alternative, the material can be comprised primarily of graphite. The plurality of abrasive particles can be formed of MoO₃, SbO₃, Na2SiO₃, or NaSO₄, in addition to other known materials. The assembly can be a sliding assembly and/or a rotational assembly, and can further be in the form of a valve.

In accordance with another embodiment of the present invention, a packing arrangement is disposed about an operating member. The packing arrangement includes a plurality of components. At least one of the plurality of components has a plurality of abrasive particles incorporated therein, and is suitable for removing material adhering to the operating member.

In accordance with certain embodiments of the present invention, the plurality of components can include a packing follower, at least one bushing, an anti-extrusion ring, and a plurality of washers.

In accordance with further example embodiments of the present invention, the operating member can have a surface coating thereon. The surface coating can be formed of chrome, or nickel, in addition to other known materials.

In accordance with yet another embodiment of the present invention, a packing arrangement is disposed about an operating member. The packing arrangement includes a plurality of components. At least one of the plurality of components has a plurality of abrasive particles incorporated therein. At least one of the plurality of components is also suitable for removing a build up of material on the operating member.

### BRIEF DESCRIPTION OF THE DRAWINGS

The present invention will become better understood with reference to the following description and accompanying drawings, wherein:

FIG. 1 is a diagrammatic cross-sectional view of a portion of a sliding assembly illustrating a packing arrangement in accordance with one aspect of the present invention;

FIG. 2 is a perspective illustration of a sealing ring of the packing arrangement in accordance with one aspect of the present invention;

FIGS. 3A, 3B, and 3C are diagrammatic illustrations of an operating member of the sliding assembly in different positions with the sealing ring removing material from the operating member in accordance with one aspect of the present invention;

FIGS. 4A and 4B are diagrammatic illustrations of material being removed from an operating member by the packing arrangement in an alternative manner in accordance with one aspect of the present invention; and

FIGS. 5A and 5B are diagrammatic cross-sectional views of a sealing ring of a packing arrangement in a rotating assembly according to one example embodiment of the present invention.

### DETAILED DESCRIPTION

An illustrative embodiment of the present invention relates to a system and method for removing unwanted material adhered to an operating member. The term operating member indicates a component or part of a mechanical device that experiences some form of movement, for example sliding or rotational movement during normal operation. In typical applications, the operating member requires some form of packing to provide a fluid seal that also advantageously provides lubrication to reduce wear by the operating member caused by frictional contact with the packing. The illustrative embodiment that includes an operating member can be expressed as the inclusion of abrasive particles in a sealing ring or guide surface within a packing arrangement, or packing set, of a valve. The abrasive particles slide against the operating member as the operating member moves within the valve, and remove material adhered, affixed or coupled to the operating member. The removal of the material substantially eliminates the buildup of the material, thereby avoiding damage to the components of the packing from any adhered material during mechanical cycling of the operating member.

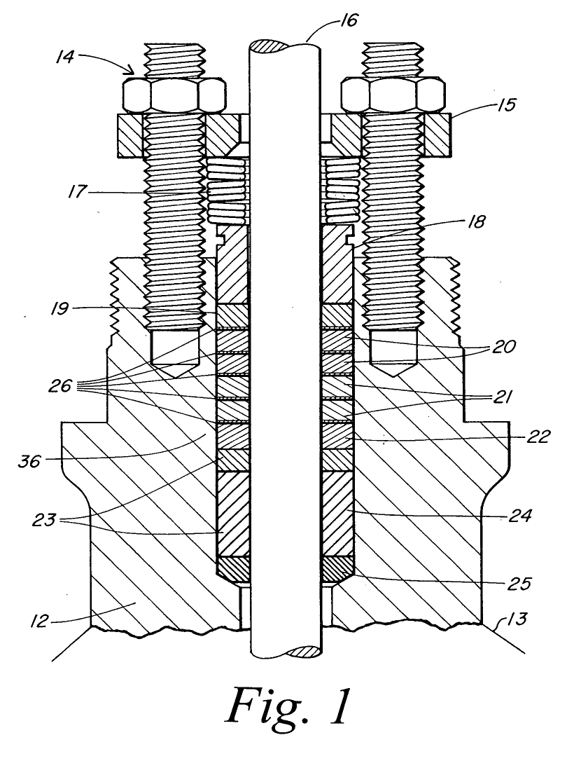

FIGS. 1 through 5B, wherein like parts are designated by like reference numerals throughout, illustrate example embodiments of packing arrangements with material removal properties according to the teachings of the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1 illustrates, in partial cross-section, an example device having a sliding valve stem or operating member 16 in a control valve, of which only a bonnet 13 portion is shown. The present invention has many useful applications in a number of different sliding and rotating assemblies. The operating member 16 is slidably and/or rotatably movable within the bonnet 13, depending on the type of assembly. A packing set or packing arrangement 36 surrounds the operating member 16 to provide a fluid seal. The operating member 16 can be any type of valve member that rotates, slides, or performs a combination thereof. The operating member 16 in the case of a valve can be in the form of, for example, a valve shaft or other stem or shaft-like component. The packing arrangement 36 can be formed of a number of different components combined together to perform different functions. The functions include sealing the operating member 16 against leakage, while enabling the operating member 16 to move within the bonnet 13. Some such assemblies can be of different valve types, including valves having a rotating or sliding member that requires a fluid tight seal. The packing arrangement 36 creates a fluid seal around the operating member 16 by a compression force being exerted upon the packing arrangement 36 by the packing flange 15 and fasteners such as bolts 14.

The packing arrangement 36 can comprise any selected number of components arranged in any desired manner. Examples of suitable packing arrangements include single packing arrangements, double packing arrangements, leak-proof packing arrangements, and the like. In the example embodiment illustrated the packing arrangement 36 includes springs 17 coupled with a packing follower 18. On either side of a main portion of the packing, one or more carbon guide bushings 19 and 23 are provided. Working inwardly on the packing arrangement, next in the arrangement are two anti-extrusion rings 20 and 22. In the middle of the packing arrangement 36 are one or more sealing rings in the form of graphite packing rings 21. In accordance with the present invention, the sealing rings or graphite packing rings 21 include abrasive particles 38 as described in greater detail below. The complete packing arrangement 36 is contained within the packing box 24 and positioned atop a packing box ring 25. Interspersed between each of the above identified components is a plurality polytetrafluoroethylene (PTFE) packing washers 26.

The specific arrangement and corresponding function of each of the components found in a packing arrangement such as the packing arrangement 36 illustrated herein are well understood by one of ordinary skill in the art. For example, the packing arrangement 36 includes the anti-extrusion rings 20 and 22, which can include one or more components. The anti-extrusion rings 20 and 22 can be separate from a wiper element, or can be the same component. For purposes of the present disclosure, the anti-extrusion rings 20 and 22 and the wiper are interchangeable as being components in a packing arrangement disposed at outer ends of the packing arrangement. The anti-extrusion rings 20 and 22 are useful in cleaning any superfluous material off the operating member, and/or preventing extrusion of other packing arrangement 36 components.

The two graphite packing rings 21 are disposed between the anti-extrusion rings 20 and 22, along with the plurality of PTFE packing washers 26. The graphite packing rings 21 are a specific example of what is generally known as a sealing ring, and thus provide the main sealing function of the packing arrangement 36. The carbon guide bushings 32 are disposed outside of the anti-extrusion rings 20 and 22. Common operating pressures for control valves can typically exceed several thousand pounds per square inch (psi). At these operating pressures, the graphite material within the graphite packing rings 21 has a tendency to extrude. Therefore, the anti-extrusion rings 20 and 22 serve to prevent the extrusion of the graphite material out of the packing arrangement 36. Continuing, the packing box ring 25 serves to make the bottom of the packing arrangement 36 flat. It should be noted again that the illustrative packing arrangement 36 is merely one of many possible combinations of packing components known to one of ordinary skill in the art. The teachings of the present invention are by no means limited to the particular arrangement of components within the packing arrangement 36 as illustrated herein.

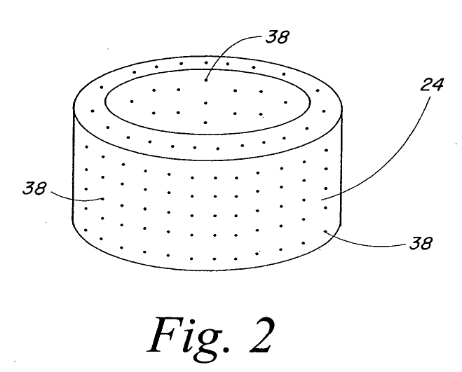

FIG. 2 is a diagrammatic illustration of an example graphite packing ring 21 in accordance with the present invention. The graphite packing ring 21 can be formed of such materials as flexible graphite, or flexible graphite with for example, PTFE. The flexible graphite that forms the graphite packing ring 21 serves as lubrication for the operating member 16. In conventional valve packing arrangements, the graphite eventually separates from the graphite packing ring 21 and adheres to the operating member 16 as the operating member 16 moves. The adhered graphite subsequently damages the packing arrangement 36 as the operating member 16 moves through the packing arrangement 36.

However, in accordance with the present invention, the graphite packing ring 21 also includes a plurality of abrasive particles 38 disposed throughout the graphite packing ring 21 composition. The abrasive particles 38 remove adhered graphite and other materials from the operating member 16 before the materials build up and damage the packing arrangement 36 or the operating member 16 during mechanical cycling.

The term “abrasive particles” as utilized herein is intended to include any suitable particle that is included within or forms part of the sealing ring, such as the graphite packing ring 21, or within other packing components. The particles are suitable for removing material from an operating member operating within the packing arrangement 36. The size, composition, and concentration of the abrasive particles can vary to modify the abrasive characteristics of the sealing ring. The hardness, composition, and morphology of the abrasive particles can also vary to work in conjunction with the operating member without damaging the surface finish of the operating member. The operating member can likewise have a surface coating of a relatively harder material to prevent damage to the surface finish of the operating member. Alternatively, the abrasive particles can be incorporated into other packing components of the packing arrangement, or in an additional component to the packing arrangement having the sole purpose of keeping the operating member clean and free of material buildup. One of ordinary skill can readily determine the material type of the abrasive particles by considering the type and material of the operating member, the type of material build-up, the type of valve, as well as other parameters and valve characteristics.

Also, as previously stated above, additional factors that are taken into consideration when determining the design of the abrasive particles include the hardness, composition, and morphology of the abrasive particles 38 relative to the operating member 16 material. More specifically, the hardness, composition, and morphology of the abrasive particles 38 can be varied taking into account the material of the operating member 16. In addition, a relatively harder coating can be placed on the operating member 16, such as hard industrial chrome, or nickel, to accommodate a more aggressive abrasive. Example materials that can be used to form the abrasive particles include, but are not limited to, MoO₃, SbO₃, Na2SiO₃, and NaSO₄.

At conventional operating temperatures for some valves utilizing the graphite packing, the graphite material within the graphite packing rings 21 has a tendency to extrude. Therefore, the anti-extrusion rings 20 and 22 serve to prevent the extrusion of the graphite material out of the packing arrangement 36. However, at lower temperatures, such as ambient conditions of approximately 70° F., the same graphite material within the graphite packing rings 21 has a tendency to adhere to the operating member 16. This tendency to adhere causes the eventual graphite buildup and eventual destruction of the packing arrangement 36 if steps are not taken to remove the adhered material.

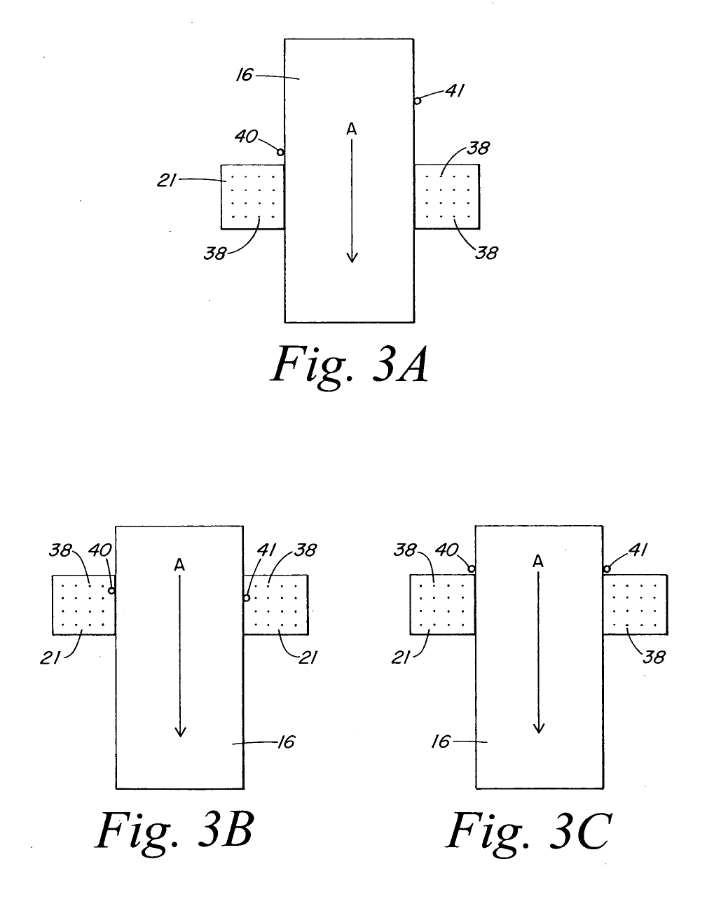

FIGS. 3A, 3B, and 3C illustrate only a portion of the packing arrangement 36 for the sake of simplicity. More specifically, the graphite packing ring 21 and the movement of the graphite packing ring 21 relative to the operating member 16 are shown. In FIG. 3A, the graphite packing ring 21 includes a plurality of abrasive particles 38. Graphite particles 40 and 41 have adhered to the operating member 16. At the illustrative point in the mechanical cycle, the operating member 16 is moving in a downward direction, in the direction of arrow A.

In FIG. 3B, the operating member 16 is shown after having moved further down through the graphite packing ring 21. As is shown, the graphite packing ring 21 and the abrasive particles 38 therein remove the graphite particles 40 and 41 from the operating member 16 and re-deposit the graphite particles 40 and 41 back within the graphite packing ring 21.

In FIG. 3C, an alternative result is illustrated. The operating member 16, after having originated in the position as shown in FIG. 3A, again moves further down through the graphite packing ring 21. The movement of the operating member 16 relative to the graphite packing ring 21 results in the graphite particles 40 and 41 being pushed to a top portion of the operating member 16. In conventional valves, such graphite buildup 40 pushed to the top portion of the operating member 16 collects on top of the packing arrangement 36 and subsequently can be physically removed. Alternatively, the buildup 40 can be innocuously collected externally where no damage is done to the packing arrangement 36 or to the seal integrity. In addition, the anti-extrusion rings 20 and 22 can pick up the graphite particles 40 and 41 and push them further outwardly.

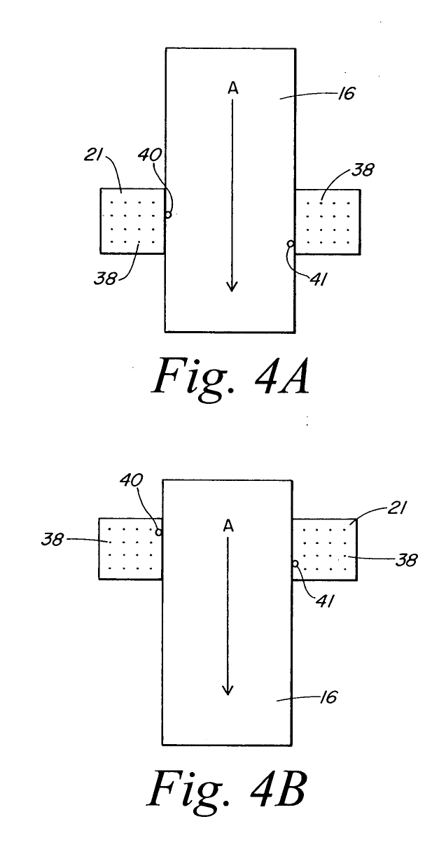

FIGS. 4A and 4B show still another possible outcome resulting from the inclusion of the abrasive particles 38 in the graphite packing ring 21. FIG. 4A shows the abrasive particles 40 and 41 adhered to the operating member 16, while the graphite packing ring 21 is positioned next to the location of the graphite particles 40 and 41. FIG. 4B shows the operating member 16 after having moved in the direction of arrow A. As shown, before the graphite packing ring 21 passed completely by the graphite particles 40 and 41 that were adhered to the operating member, the abrasive particles 38 scrape the adhered graphite particles 40 and 41 off of the operating member 16 and re-deposit the graphite particles 40 and 41 on within the graphite packing ring 21. As such, the graphite particles 40 and 41 cannot continually accumulate on the operating member 16 because they are removed by the abrasive particles 38 and re-deposited or re-positioned back on the graphite packing ring 21 each time the operating member 16 changes position. Alternatively, the graphite particles 40 and 41 can have existed adhered to the operating member 16 prior to the graphite packing ring 21 reaching the particles, and the abrasive particles 38 then act to scrape the graphite particles off of the operating member 16 and re-deposit the graphite particles back on the graphite packing ring 21.

The inclusion of the abrasive particles 38 at the location of the graphite packing ring 21 within the packing arrangement 36 effectively eliminates adhesion of graphite and other materials to the operating member 16. Rather than allowing the graphite and other materials to adhere to the operating member and then be subsequently removed by outer portions of the packing arrangement 36 (such as the wiper or anti-extrusion ring 20 or 22), the graphite packing ring 21 of the present invention removes the graphite at an operating location where the graphite particles can do the most damage. This reduces the likelihood of the graphite packing ring 21 being damaged by the graphite and other materials that have yet to come in contact with the outer rings, such as the anti-extrusion rings 20 and 22. In addition, valves having a very short linear travel, or valves that oscillate or rotate around a single set point, can take advantage of the ability to remove the material buildup at the graphite packing ring 21. Further, valves having a rotary operating member 16 motion cannot make use of anti-extrusion rings 20 and 22 and normal mechanical cycling, because such components do not reach the location of the seal from which the graphite is removed. Therefore, the graphite packing ring 21 having the abrasive particles 38 therein enables the graphite packing ring 21 to remove the undesirable buildup and push excess material and particles away from the seal.

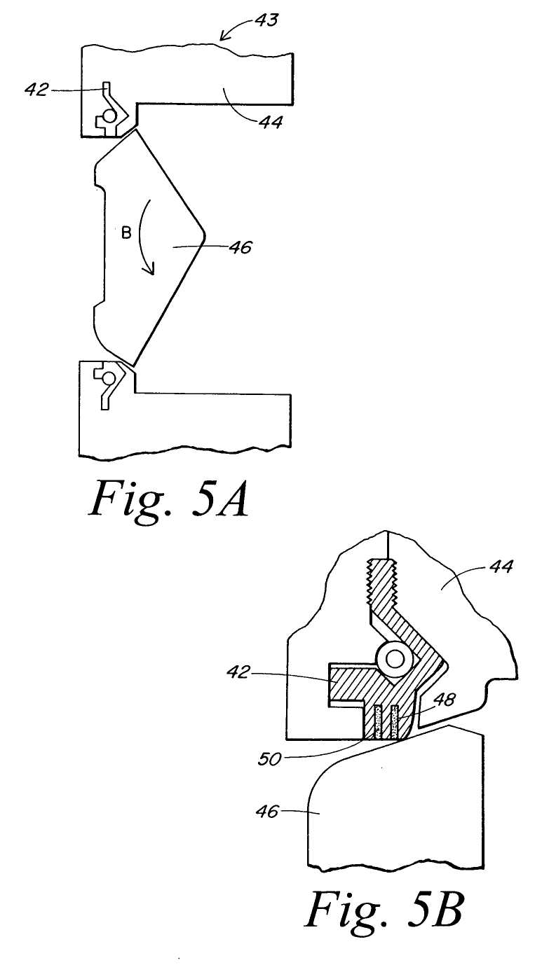

FIGS. 5A and 5B illustrate another example embodiment of a seal or seal ring in the form of a graphite sealing ring 42 for use in accordance with the present invention. It should again be noted that while the following is another example illustration, the invention is not limited to the examples illustrated herein. Rather, the inclusion of abrasive particles in various components of a rotating or sliding assembly, or including valves and valve seal arrangements, or bearing arrangements, can be utilized in a number of different configurations as understood by one of ordinary skill in the art.

The illustrated graphite sealing ring 42 is a seal design for use with a butterfly valve 43, or rotating type valve configuration. The butterfly valve 43 includes a valve body 44 and a disc 46 that rotates or pivots to control fluid flow through the valve 43. The dynamic seal between the disc 46 of the butterfly valve 43 and the graphite sealing ring 42 is accomplished by introduction of a hoop stress induced into the graphite sealing ring 42 by rotation of the disc 48.

The graphite sealing ring 42 can be made of, for example, graphite with strips of PTFE 48 having a plurality of abrasive particles 50 provided therein. The PTFE strips 48 of the graphite sealing ring 42 can adhere to, for example, a flexible seal carrier (not shown), or to the material of the graphite sealing ring 42. The purpose of the abrasive particles in the PTFE strips 48 is to scrape off any graphite particles that adhere to the operating member, in the form of the disc 46, in the same manner as detailed in the above described embodiments.

An example embodiment of the graphite sealing ring 42 can be made of PTFE (or equivalent) and graphite as shown. For example, a laminate structure can be formed with interleaved layers of PTFE strips 48 or equivalent, including abrasive particles 50. The sections of graphite can be, for example, nominally about 0.03 inches thick, while the layers of PTFE strips 48 can be about 0.005 inches thick. The PTFE strips 48 provide lubricating function, while the abrasive particles 50 scrape off graphite particles adhering to the disc 46. The PTFE strips 48 can be bonded with phenolic adhesive on all surfaces and bonded to the graphite to form the laminate structure. The laminate is then heated and loaded with pressure to cure the bond. Changing the thickness of the graphite portions and the PTFE strips 48 can control the rigidity of the graphite sealing ring 42. The compression caused by the disc 46 abutting the graphite sealing ring 42 applies an initial gasket seating load to the graphite to prevent leakage through the graphite layers. The interleaved layers within the laminate structure can also be formed from stainless steel, such as UNS 31600, or other equivalents as known to one of ordinary skill in the art, to provide improved seal characteristics.

The present invention provides a system and method for removing unwanted material adhered to an operating member of a sliding or rotating assembly. The illustrative embodiment can be expressed as the inclusion of abrasive particles in a sealing component a packing, or similar, arrangement or packing set, of a dynamic device or system. The abrasive particles slide against the operating member as the operating member moves, and remove material adhered, affixed, or coupled to the operating member. The removal of material occurs before the buildup of material is thick enough to damage components of the packing arrangement during mechanical cycling of the operating member. The inclusion of the abrasive particles at the location of the graphite deposition to the operating member effectively eliminates adhesion of graphite and other materials to the operating member. The present invention removes the graphite at an operating location where the graphite particles can do the most damage.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

1. A seal for a use in conjunction with an operating member of a dynamic assembly, comprising:
a graphite composition forming the seal; and
a plurality of abrasive particles incorporated into the graphite composition and positioned within the seal in a location suitable for removing adhering particles deposited on the operating member of the dynamic assembly.

2. The seal of claim 1, wherein the dynamic assembly comprises a valve.

3. The seal of claim 1, wherein the graphite composition comprises a laminate structure.

4. The seal of claim 1, wherein the graphite composition further comprises graphite combined with polytetrafluoroethylene.

5. The seal of claim 1, wherein the plurality of abrasive particles are adapted to remove the adhering particles while not substantially damaging a surface of the operating member.

6. The seal of claim 1, wherein the graphite composition is formed into the shape of a ring having an aperture sized to accommodate the operating member.

7. The seal of claim 1, wherein the plurality of abrasive particles are comprised of at least partially of at least one of MoO₃, SbO₃, Na2SiO₃, and NaSO₄.

8. The seal of claim 1, wherein the seal comprises a laminate structure of graphite and PTFE, the PTFE further including the plurality of abrasive particles.

9. A packing arrangement disposed about an operating member of an assembly, the packing arrangement comprising:
a plurality of components;
wherein at least one of the plurality of components comprises a seal having a plurality of abrasive particles incorporated therein suitable for removing material adhering to the operating member.

10. The packing arrangement of claim 9, wherein the plurality of components further comprises a packing follower, at least one bushing, at least one anti-extrusion ring, and a plurality of washers.

11. The packing arrangement of claim 9, wherein the seal is formed of at least one of graphite and polytetrafluoroethylene.

12. The packing arrangement of claim 9, wherein the plurality of abrasive particles are adapted to remove material adhering to the operating member during normal assembly operation.

13. The packing arrangement of claim 9, wherein the material comprises a plurality of graphite particles.

14. The packing arrangement of claim 9, wherein the operating member further includes a surface coating thereon.

15. The packing arrangement of claim 14, wherein the surface coating is comprised of at least one of chrome and nickel.

16. The packing arrangement of claim 9, wherein the plurality of abrasive particles are selected to be suitable for removing the material while not substantially damaging a surface of the operating member.

17. The packing arrangement of claim 9, wherein at least one of the plurality of components further comprises a plurality of abrasive particles incorporated therein and suitable for removing material adhering to the operating member.

18. The packing arrangement of claim 9, wherein the plurality of abrasive particles are comprised at least partially of at least one of MoO₃, SbO₃, Na2SiO₃, and NaSO₄.

19. The packing arrangement of claim 9, wherein the assembly comprises a valve.

20. A packing arrangement disposed about an operating member, the packing arrangement comprising:
a plurality of components;
wherein at least one of the plurality of components comprises a plurality of abrasive particles incorporated therein and suitable for removing a collection of material on the operating member.

21. The packing arrangement of claim 20, wherein the plurality of abrasive particles are adapted to remove the material from the operating member during normal operation.

22. The packing arrangement of claim 20, wherein at least one of the plurality of components comprises a seal formed of a composition of graphite and abrasive particles.
